(19) United States
(12) Patent Application Publication
(10) Pub. No.: US 2014/0338137 A1
(43) Pub. Date: Nov. 20, 2014

(54) LOADING RAMP

(71) Applicants: Harold W. Stokes, Houston, TX (US); Daniel W. Stokes, Cypress, TX (US); Justin W. Stokes, Cypress, TX (US)

(72) Inventors: Harold W. Stokes, Houston, TX (US); Daniel W. Stokes, Cypress, TX (US); Justin W. Stokes, Cypress, TX (US)

(21) Appl. No.: 14/269,398

(22) Filed: May 5, 2014

Related U.S. Application Data
(60) Provisional application No. 61/855,442, filed on May 15, 2013.

(51) Int. Cl. B65G 69/30

(52) U.S. Cl. CPC B65G 69/30
USPC 14/71.1

(57) ABSTRACT

Techniques are disclosed relating to a loading ramp. In one embodiment, the ramp includes a hitch mount that includes a horizontal portion configured to detachably couple to a tow hitch and a vertical portion extending upwards from the horizontal portion. In this embodiment, the ramp includes first and second coupled ramp members configurable as a ramp in an open position. In this embodiment, the first ramp member is rotatably coupled to the vertical portion of the hitch mount. In the open position, the ramp members may define a ramp surface usable to load light vehicles or cargo, for example, into a truck bed. In this embodiment, the first and second ramp members are configurable in a closed overlapping position in which the first and second ramp members are substantially parallel to the horizontal portion of the hitch mount.

### PRIORITY DATA

This application claims the benefit of Provisional Application No. 61/855,442, filed on May 15, 2013 which is incorporated by reference herein in its entirety.

### BACKGROUND

1. Technical Field

This disclosure relates to vehicle accessories and more particularly to loading ramps.

2. Description of the Related Art

Pickup trucks typically have boxes or beds with the floors being substantially elevated above the ground surface. This creates an issue with trying to load large and heavy items, such as Motorcycles, ATV's, large pieces of equipment or materials into the box. Also, the user may often desire more cargo space than provided by the bed.

There have been other devices used to create ramps for pickup trucks. One known prior disclosure is a COMBINATION PICKUP TRUCK BED EXTENDER-FOLDABLE RAMP, U.S. Pat. No. 5,752,800, issued on May 19, 1998 and invented by Darryl Brincks et al and comprising a mounting plate, an extension plate mounted to the mounting plate, collapsible sections, a plurality of side bed extenders, and a plurality of latches.

Another known prior disclosure is a PORTABLE LOADING RAMP FOR A PICKUP TRUCK, U.S. Pat. No. 6,296,290, issued on Oct. 2, 2001 and invented by Nathan Wolf et al and comprising a foldable ramp which extends from the truck bed to the ground, which is attached to hitch, and can be used to help support the small vehicle.

Another known prior disclosure is a RAMP FOR LOADING SMALL MOTORIZED VEHICLES ON PICKUP TRUCKS, U.S. Pat. No. 4,700,421, issued on Oct. 20, 1987 and invented by Tommy C. Gladney et al and comprising a flexible support sheet adapted to extend from the truck box and the ground, means to secure the support sheet and the truck box to the ground, and an elongate tensioning member for supporting the support sheet.

Another known prior disclosure is a PICKUP TRUCK LOADING RAMP, U.S. Pat. No. 4,795,304, issued on Jan. 3, 1989 and invented by James D. Dudley and comprising a pair of hinged connected ramp panels and a plurality of legs.

Another known prior disclosure is a PICKUP TRUCK BED EXTENDER, RAMP, AND TAILGATE, U.S. Pat. No. 5,816,638, issued on Oct. 6, 1998 and invented by William Bryan Pool III, and comprising two side frame members, a gate member, a latching means, and a pivoting control means.

None of these prior disclosures describes or suggests aspects of various embodiments of a loading ramp as described below.

### SUMMARY

Techniques are disclosed relating to a loading ramp.

In one embodiment, the ramp includes a hitch mount that includes a horizontal portion configured to detachably couple to a tow hitch and a vertical portion extending upwards from the horizontal portion. In this embodiment, the ramp includes first and second coupled ramp members configurable as a ramp in an open position. In this embodiment, the first ramp member is rotatably coupled to the vertical portion of the hitch mount. In the open position, the ramp members may define a ramp surface usable to load light vehicles or cargo, for example, into a truck bed. In this embodiment, the first and second ramp members are configurable in a closed overlapping position in which the first and second ramp members are substantially parallel to the first portion of the hitch mount. In this closed position, the ramp members may serve as a bed extender. In some embodiments, the first and second ramp members are also configurable in an upright, closed position in which the first and second ramp members are substantially perpendicular to the horizontal portion of the hitch mount.

In some embodiments, the horizontal and/or vertical portions of the hitch mount are adjustable. This may allow alignment of the ramp with a tailgate or bed or a truck in some embodiments. In some embodiment, the ramp includes a support member. In some embodiments, the ramp includes one or more stabilizing members to support the ramp in the open position. In some embodiments, the ramp includes a tow hitch extension.

These and other embodiments will become apparent upon reference to the following description and accompanying drawings.

### BRIEF DESCRIPTION OF THE DRAWINGS

FIG. 1 is a diagram illustrating one embodiment of a loading ramp.

FIG. 2 is a side elevational diagram of one embodiment of a loading ramp in an open position.

FIGS. 3A-3B are fragmented side elevational diagrams of exemplary embodiments of hitch mount couplings.

FIG. 4 is a side elevational diagram of one embodiment of a loading ramp in a closed, horizontal position.

FIG. 5 is a side elevational diagram of another embodiment of a loading ramp in a closed, horizontal position.

FIG. 6 is a side elevational diagram of one embodiment of a laoding ramp in a closed, upright position.

FIG. 7 is a flow diagram illustrating one embodiment of a method for operating a loading ramp.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various units or components may be described or claimed as “configured to” perform a task or tasks. In such contexts, “configured to” is used to connote structure by indicating that the units/components include structure that performs the task or tasks during operation. As such, the unit/component can be said to be configured to perform the task or operate in a given position even when the specified unit/component is not currently operational (e.g., is currently in a different position, is not operating, or is performing a different operations). The units/components used with the “configured to” language include structure configured to implement the position/operation, etc. Reciting that a unit/component is “configured to” perform one or more tasks is expressly intended not to invoke 35 U.S.C. §112(f) for that unit/circuit/component, unless the term “configured to” is used in conjunction with the term “means.”

### DETAILED DESCRIPTION

Techniques are disclosed relating to embodiments of a loading ramp that may also be used as a bed extender and/or cargo carrier for loading small vehicles and items for being carried by a truck. In some embodiments, the loading ramp is carried by the truck in a closed position such that the loading ramp does not limit the storage space provided by the truck, and, in particular embodiments, makes available storage space provided by the truck that would otherwise be occupied. In some embodiments, when in a closed position, the loading ramp can be used as a bed extender giving the ability to carry loads that are longer than the truck bed.

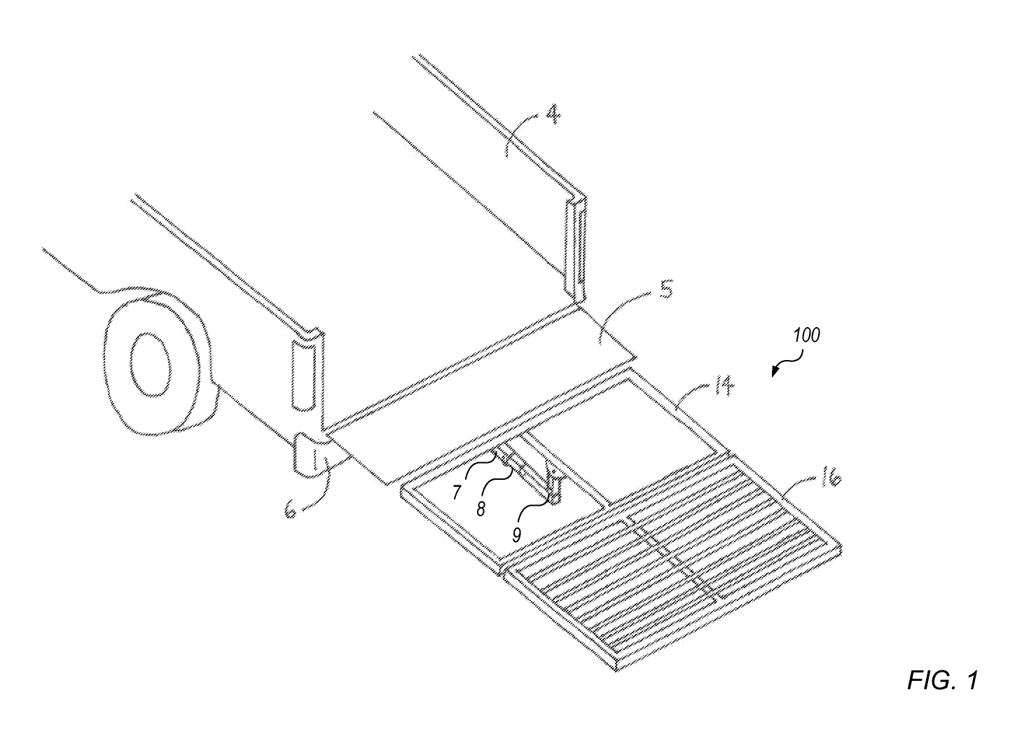

FIG. 1 illustrates one embodiment of a ramp 100. In the illustrated embodiment, ramp 100 includes a first ramp member 14, a second ramp member 16, and a hitch mount 9 detachably coupled to a tow hitch 7 via coupling member 8. Ramp member 14 is shown without rods or a grating in FIG. 1 in order to show elements 7-9, but ramp member 14 may include rods similar to ramp member 16 or any other appropriate ramp surface in various embodiments.

In the illustrated embodiment, tow hitch 7 is attached to truck 4 (which includes tailgate 5 and rear bumper 6). In some embodiments, tow hitch 4 is a receiver-type hitch. In other embodiments, ramp 30 may be configured to detachably couple to various types of hitches in addition to receiver type hitches. For embodiments configured to use receiver-type hitches, various dimensions may be implemented, including without limitation: 1.25 inch, 2 inch, 2.5 inch, etc. In some embodiments, coupling member 8 may be an adapter element for a particular tow hitch size and/or type.

In various embodiments, the first and second ramp members 14 and 16 may define a ramp surface that is usable to support loading of a small vehicle into truck 4. Examples of vehicles to be loaded include, without limitation: motorcycles, all-terrain vehicles (ATVs), lawn mowers, etc. The ramp members 14 and 16 may comprise a continuous solid surface or may include rods or a grating, e.g., to reduce weight. In the illustrated embodiment, the ramp includes two ramp members 14 and 16. In other embodiments, the ramp may include any of various numbers of foldable or otherwise collapsible ramp portions. In various embodiments, the ramp may be constructed of one or more materials, including without limitation: steel, aluminum, composite materials, etc.

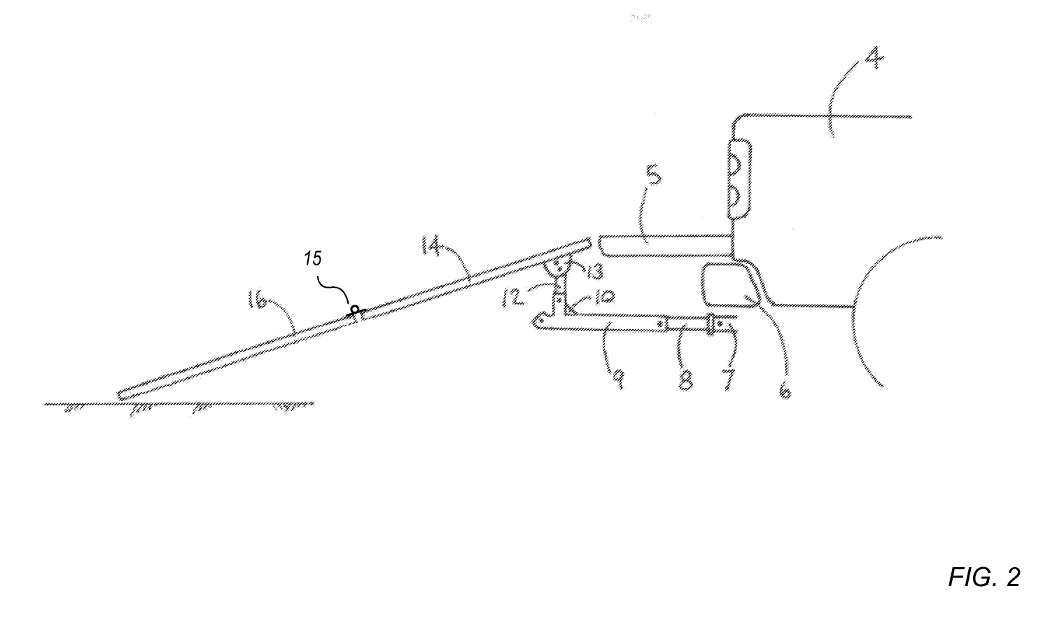

FIG. 2 illustrates one embodiment of a ramp in an open position. In the illustrated embodiment, ramp members 14 and 16 are configured as a ramp from the ground to tailgate 5. In the illustrated embodiment, ramp members 14 and 16 and hingedly coupled using hinge 15. In other embodiments, ramp members may be slidably coupled (e.g., using a rail system) or coupled using any of various other couplings. In the illustrated embodiment, ramp member 14 is rotatably coupled to hitch mount 9 via rotation element 13. In one embodiment, one of the pins shown in rotation element 13 is fixed, while another of the pins is removable to allow rotation element 13 to rotate about the fixed pin.

The gusset plate 10, in the illustrated embodiment, is welded into place on mounting member 9 to add strength. Gusset plate 10 may be permanently welded, in some embodiments. In the illustrated embodiment, hitch mount 9 includes a horizontal portion and a vertical portion. Coupling member 8 may be described as included in or slidably coupled to the horizontal portion. In the illustrated embodiment, the horizontal portion of hitch mount 9 is coupled to tow hitch 7. Coupling member 12 may be described as included in or slidably coupled to the vertical portion. In the illustrated embodiment, the vertical portion of hitch mount 9 is rotatably coupled to ramp member 14 via rotation element 13. In the illustrated embodiment, the vertical portions extends upward from the horizontal portion, allowing ramp member 14 to align with tailgate 5. In the illustrated embodiment, hitch mount 9 and coupling members 8 and 12 are slidably coupled in order to adjust the ramp in the vertical and/or horizontal direction to fit various vehicle sizes.

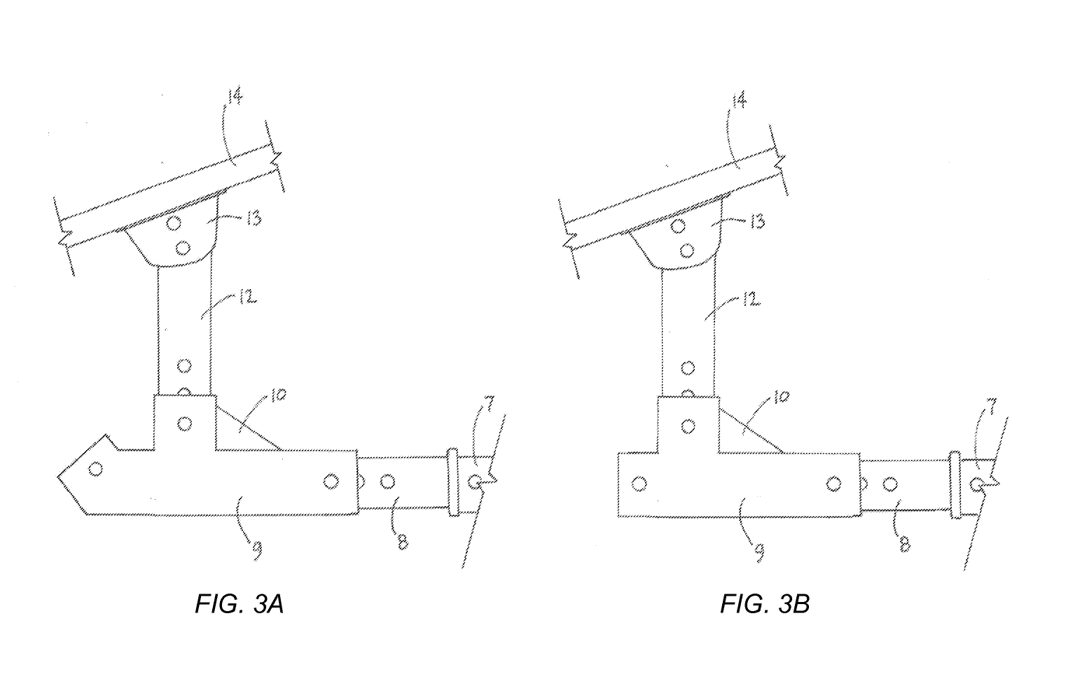

FIGS. 3A and 3B illustrate exemplary embodiments of hitch mount 9. In the illustrated embodiments, hitch mount 9 is slidably coupled to coupling members 8 and 12 using a pin and slot configuration in which a pin can be inserted in different slots in order to adjust the distance between tow hitch 7 and coupling member 12 (e.g., based on the length of tailgate 5) and/or a distance between tow hitch 7 and ramp member 14 (e.g., in order to align ramp member 14 with tailgate 5). In other embodiments, other configurations may be used in addition to or in place of the pin and slot configuration in order to adjust these distances using slidably coupled members. Pin and slot techniques are well known in the context of tow hitches; and adding additional slots may allow for adjustment by changing the slot in which the pin is inserted.

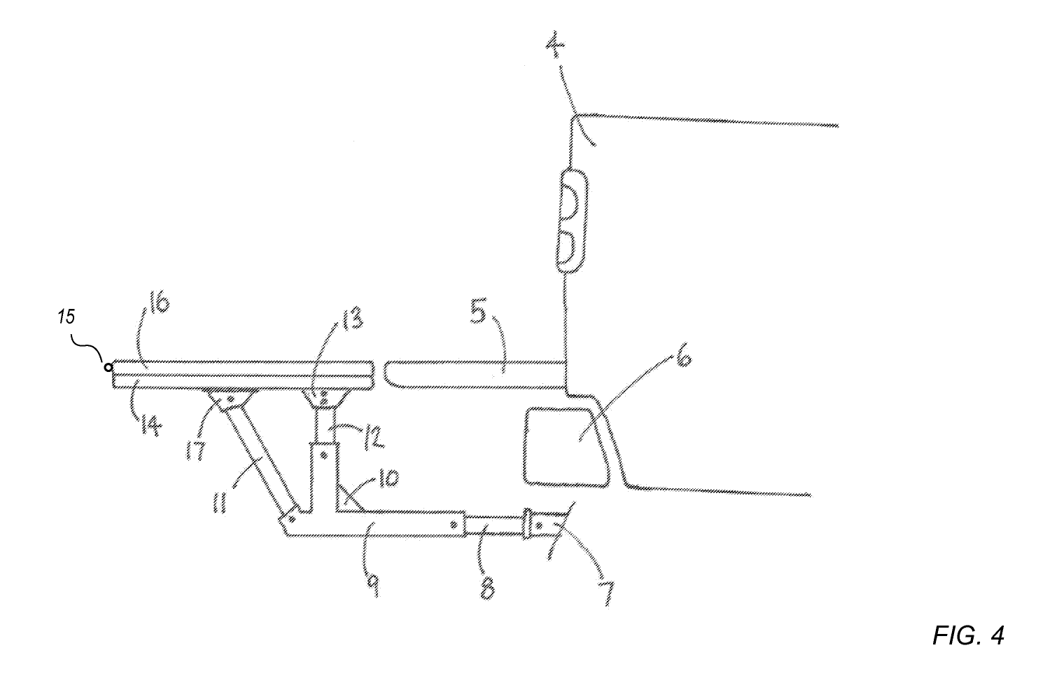

In the embodiment of FIG. 3A, hitch mount 9 includes an opening for a support member 11, discussed in further detail below with reference to FIG. 4. In the embodiment of FIG. 3B, hitch mount 9 includes an open end which may be coupled to support member 11 or alternately used as a tow hitch extension. For example, the opening in FIG. 3B may be used as an extended receiver-type tow hitch, allowing a user to connect a trailer ball hitch or other type of hitch to pull a trailer even when the ramp is coupled to tow hitch 7.

FIG. 4 shows one embodiment of the ramp in a horizontal closed position. In the illustrated embodiment, ramp members 14 and 16 are overlapping and closed, e.g., so that truck 4 can be driven without decoupling hitch mount 9. The degree of overlap may vary in different embodiments, including 100% overlap, 50%, 70%, 80%, etc. In the illustrated embodiment, ramp member 16 may be used to extend the bed of truck 4, e.g., to carry additional cargo. In the illustrated embodiment, support member 11 is detachably coupled to hitch mount 9 and ramp member 14 and is configured to provide support to ramp member 14. In some embodiments, the ramp does not include support member 11. However, support member 11 may allow carrying of heavier cargo in some embodiments. In one embodiment, the distance between hitch mount 9 and coupling 17 (which may be fixed or rotatable in different embodiments) is adjustable. For example, support member 11 may be slidable relative to hitch mount 9 (e.g., in one embodiment, hitch mount 9 may include a hole in the lower portion to allow support member 11 to be shortened using a pin and slot configuration). Thus, both support member 11 and coupling member 12 may be adjustable to alter the height and/or angle of the closed ramp members 14 and 16.

In the illustrated embodiment, ramp members 14 and 16 are substantially parallel to the horizontal portion of hitch mount 9. “Substantially parallel” refers to elements that are parallel to within at least 7 degrees. In other embodiments, different maximum deviation angles may be considered parallel, such as 1, 2, 3, 5, 9, 15 degrees etc. In one embodiment, a pin in rotation element 13 is detachably coupled to hold ramp members 14 and 16 in a substantially parallel position relative to hitch mount 9 in the closed position.

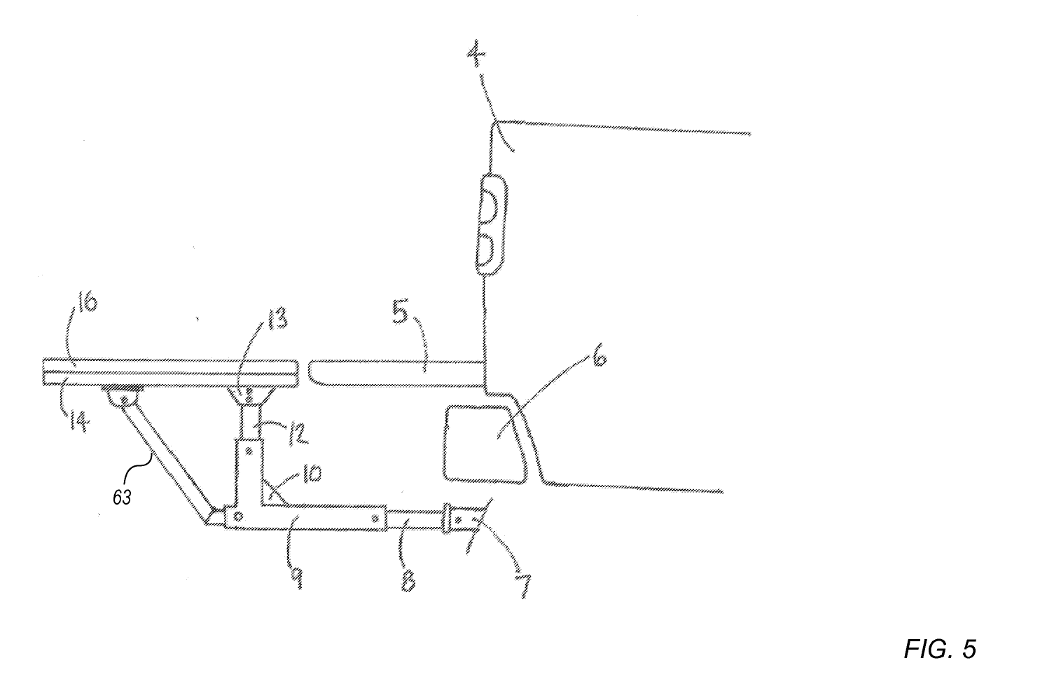

FIG. 5 shows another embodiment of the ramp in the horizontal closed position. In this embodiment, support member 11 includes an angled portion coupled to hitch mount 9. In this embodiment, support member 11 may be of fixed length. In another embodiment, support member 11 may be adjustable, e.g., support member 11 may include multiple slidably coupled elements (not shown). In one embodiment, these slidably coupled elements may utilize a pin and slot configuration to adjust the length of support member 11.

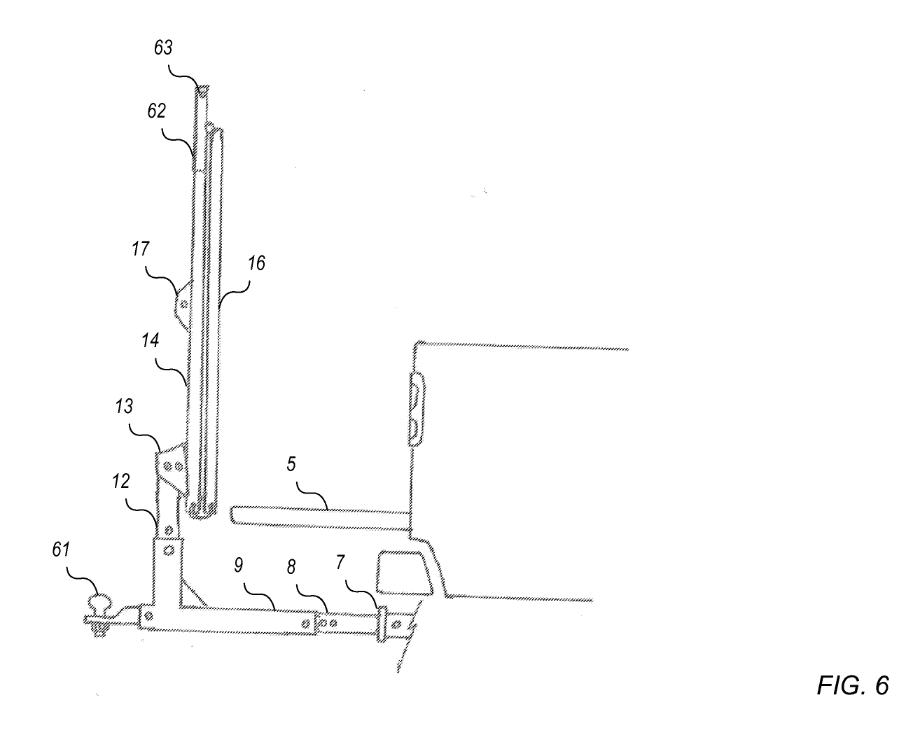

FIG. 6 shown one embodiment of the ramp in a closed, upright position. In the illustrated embodiment, ramp members 14 and 16 are substantial perpendicular to hitch mount 9. “Substantially perpendicular” refers to elements that are aligned to within at least 7 degrees of perpendicular. In other embodiments, different maximum deviation angles may be considered perpendicular, such as 1, 2, 3, 5, 9, 15 degrees etc.

Ramp members 14 and 16 in the illustrated position may be used to keep cargo in the bed of truck 4 (e.g., similarly to the typical use of a tailgate). In one embodiment, a pin in rotation element 13 is detachably coupled to hold ramp members 14 and 16 in a substantially perpendicular position relative to hitch mount 9 in the upright position.

In the illustrated embodiment, ramp member 14 includes one or more stabilizing elements 62 which include a slot 63. In this embodiment, the stabilizing elements are used to prevent the ramp from folding in the open position, e.g., when a pin is inserted into the slot and a corresponding slot in ramp member 16. In some embodiments, stabilizing elements 62 may be angle irons. In some embodiments, support member 11 may also be used to support ramp member 14 in the open position (e.g., by adjusting support member 11 to extend a shorter distance from hitch mount 9 than for the closed, horizontal position).

In the illustrated embodiment, ramp members 14 and 16 are detachably coupled or clamped at the bottom end in order to reduce relative movement of ramp members 14 and 16, e.g., caused by movement of the truck. Ramp members 14 and 16 may be similarly fastened to each other using any of various appropriate techniques in various positions. FIGS. 4 and 6 show ramp members 14 and 16 in closed horizontal and upright positions. However, other angles relative to tailgate 5, the bed of truck 4, and/or hitch mount 9 may be maintained in various embodiments. For example, ramp members 14 and 16 may be configured in a position at a 45 degree angle in order to provide additional storage space while also preventing cargo from falling out of the bed area.

In the illustrated embodiment, hitch mount 9 includes an open end as in FIG. 3B and a ball-type hitch 61 has been detachably coupled, e.g., for pulling a trailer while the ramp is attached to the truck. In various embodiments, various implements may be coupled to the distal end of hitch mount 9.

In the illustrated embodiment, element 17 is coupled to ramp member 14. In this embodiment, element 17 may be configured to detachably coupled to support member 11. In other embodiments, element 17 may be permanently coupled to support member 11 in a fixed or rotatable manner and may be configured to support and/or detachably couple to ramp member 14.

In the illustrated embodiments, the ramp is coupled to a vehicle that includes a tailgate. In other embodiments, the ramp may be coupled to a vehicle that does not include a tailgate. In these embodiments, the ramp may be adjusted in various positions to align ramp member 16 with the bed of a vehicle, for example, instead of a tailgate. In these embodiments, the ramp may serve as a replacement tailgate, providing both a bed extension in a horizontal closed embodiments and a cargo restraint in an upright closed position, for example.

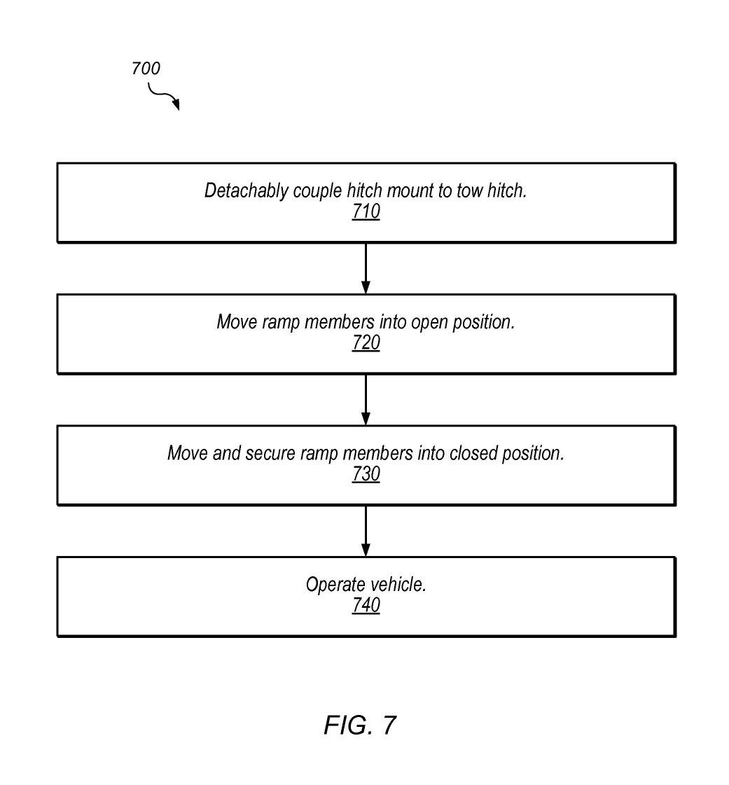

FIG. 7 illustrates one embodiment if a method 700 for using a loading ramp. The method shown in FIG. 7 may be used in conjunction with any of the elements or components disclosed herein, among other elements. In various embodiments, some of the method elements shown may be performed concurrently, in a different order than shown, or may be omitted. Additional method elements may also be performed as desired. Flow begins at block 710.

At block 710, a hitch mount is detachably coupled to a tow hitch. In one embodiment, this may include sliding the hitch mount into the tow hitch and inserting a pin to secure the hitch mount in place. In some embodiments, the coupling may be adjustable, e.g., in order to adjust the loading ramp based on the size of the vehicle. In some embodiments, block 710 may be omitted, e.g., when the hitch mount is already coupled to the tow hitch. Flow proceeds to block 720.

At block 720, ramp members are moved into an open position. In one embodiment, the ramp members are secured in the open position using stabilizing members. In the open position, the ramp may be used to load light vehicles or cargo into a bed of the vehicle that includes the tow hitch. The ramp may be supported by the coupling of the hitch mount to the tow hitch. In some embodiments, a support member may be detachably coupled between the hitch mount and a distal end of one of the ramp members to provide additional support. Flow proceeds to block 730.

At block 730, the ramp members are moved and secured into a closed position. The closed position may be horizontal or upright, for example, as shown in FIGS. 4-5 and 6 respectively. Moving the ramp to the closed position may include folding or sliding the ramp members such that they overlap. Securing the ramp in the closed position may include detachably coupling a support member and/or inserting a pin in a rotation element. In the closed position, the ramp members may extend a bed of the vehicle and/or facilitate restraining cargo. In some embodiments, the method may include clamping the ramp elements together. In some embodiments, the method may include coupling a trailer hitch to an extension in the hitch mount while the ramp is in the closed position. Flow proceeds to block 740.

At block 740, the vehicle is operated, e.g., by driving to a destination. The loading ramp may remain coupled to the vehicle in a closed position during operation. Flow ends at block 740.

Various embodiments disclosed herein may provide a portable, light loading ramp that is usable to facilitate cargo storage and/or extend a truck bed. The loading ramp may be stable based on its coupling to the tow hitch, allowing safe and efficient loading of light vehicles into a truck bed. In some embodiments, a tow hitch extension may allow pulling a trailer while the ramp is installed. In some embodiments, the ramp may be stored in multiple different positions, such as a closed horizontal position and a closed vertical position, for example. In various embodiments, the ramp may be adjustable to fit different types and/or sizes of trucks and/or tow hitches.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a hitch mount having a horizontal portion configured to detachably couple to a tow hitch and a vertical portion extending upwards from the horizontal portion;
first and second coupled ramp members configurable as a ramp in an open position, wherein the first ramp member is rotatably coupled to the vertical portion of the hitch mount;
wherein the first and second ramp members are configurable in a closed overlapping position in which the first and second ramp members are substantially parallel to the horizontal portion of the hitch mount.

2. The apparatus of claim 1, further comprising:
a support member detachably coupled to the hitch mount and the first ramp member to support the first and second ramp members in the closed overlapping position.

3. The apparatus of claim 2, wherein the support member and the vertical portion of the hitch mount are slidably coupled to the horizontal portion of the hitch mount and adjustable to alter a distance between the horizontal portion of the hitch mount and the first ramp member.

4. The apparatus of claim 3, wherein the slidable coupling utilizes a pin and slot configuration.

5. The apparatus of claim 1, wherein the horizontal portion of the hitch mount includes a slidable coupling member that is adjustable to alter a distance between the tow hitch and the vertical portion of the hitch mount.

6. The apparatus of claim 1, wherein the vertical portion of the hitch mount includes a slidable coupling member that is adjustable to alter a distance between the first ramp member and the horizontal portion of the hitch mount.

7. The apparatus of claim 1, wherein the distal end of the horizontal portion of the trailer hitch, relative to the tow hitch, includes an opening usable as an extended tow hitch.

8. The apparatus of claim 1, wherein the first and second ramp members include a plurality of substantially parallel rod members that define a ramp surface.

9. The apparatus of claim 1, wherein the first and second ramp members are hingedly coupled.

10. The apparatus of claim 1, wherein at least one of the first and second ramp members includes one or more stabilizing elements configured to support the ramp members in the open position.

11. An apparatus, comprising:
a hitch mount having a horizontal portion configured to detachably couple to a tow hitch and a vertical portion extending upwards from the horizontal portion;
first and second coupled ramp members configurable as a ramp in an open position, wherein the first ramp member is rotatably coupled to the vertical portion of the hitch mount;
wherein the first and second ramp members are configurable in a closed overlapping position in which the ramp is transportable by a vehicle that includes the tow hitch; and
wherein the vertical portion of the hitch mount includes a slidable coupling member that is adjustable to alter a distance between the first ramp member and the horizontal portion of the hitch mount.

12. The apparatus of claim 11, wherein the horizontal portion of the hitch mount includes a slidable coupling member that is adjustable to alter a distance between the tow hitch and the vertical portion of the hitch mount.

13. The apparatus of claim 11, wherein the first and second ramp members are substantially perpendicular to the horizontal portion of the hitch mount in the closed position.

14. The apparatus of claim 13, wherein the apparatus includes a pin detachably coupled to maintain the first member in the substantially perpendicular position.

15. An apparatus, comprising:
hitch means configured to detachably couple to a trailer hitch;
first and second coupled ramp members, wherein the first ramp member is coupled to the hitch means;
first means configured to:
maintain the first and second ramp members in an open position in which the first and second ramp members form a ramp between a ground surface and a bed or tailgate of a vehicle that includes the trailer hitch; and
maintain the first and second ramp members in a closed position during travel by the vehicle.

16. The apparatus of claim 15, wherein the first means is further configured to maintain the first and second ramp members in a closed horizontal position that is substantially parallel to the bed or tailgate of the vehicle.

17. The apparatus of claim 15, wherein the first means is further configured to maintain the first and second ramp members in a closed upright position that is substantially perpendicular to the bed or tailgate of the vehicle.

18. The apparatus of claim 15, further comprising means for adjusting a distance in a vertical direction between the tow hitch and the first ramp member to align the first ramp member with the bed or tailgate.

19. The apparatus of claim 15, further comprising means for adjusting a distance in the horizontal direction between the tow hitch and the first ramp member to align the first ramp member with the bed or tailgate.

20. The apparatus of claim 15, wherein the hitch means is configured to provide a tow hitch extension.
